(19) United States
(12) Patent Application Publication
(10) Pub. No.: US 2020/0020176 A1
(43) Pub. Date: Jan. 16, 2020

(54) TOLL SETTLEMENT SYSTEM AND METHOD

(71) Applicant: Kyra Solutions, Inc., Lakeland, FL (US)

(72) Inventors: LOUIS LEE SMITH, Monticello, FL (US); Christopher Neil Skene, Tallahassee, FL (US); Abdel-Hadi S. Mettawa, Coral Springs, FL (US)

(21) Appl. No.: 16/507,541

(22) Filed: Jul. 10, 2019

Related U.S. Application Data
(60) Provisional application No. 62/696,051, filed on Jul. 10, 2018.

(51) Int. Cl. G07B 15/06; G06Q 20/40; H04W 4/44; G06Q 50/26; G06Q 20/08; G06Q 20/36

(52) U.S. Cl. CPC G07B 15/063; G06Q 20/4014; H04W 4/44; G06K 9/325; G06Q 20/085; G06Q 20/3672; G06Q 50/265

(57) ABSTRACT

A computer-implemented method, computer program product and computing system for receiving a vehicle identifier concerning a vehicle passing through a tolling area that requires a toll payment; providing the vehicle identifier to one or more remote entities to determine whether the vehicle identifier is remotely-identifiably by a specific remote entity; and if the vehicle identifier is remotely-identifiably by a specific remote entity, remotely-effectuating the toll payment concerning the tolling area via the specific remote entity.

### RELATED APPLICATION(S)

This application claims the benefit of U.S. Provisional Application No. 62/696,051 filed on 10 Jul. 2018, the entire contents of which is herein incorporated by reference.

### TECHNICAL FIELD

This disclosure relates to toll collection systems and, more particularly, to toll collection systems that span multiple regions/states/countries.

### BACKGROUND

Road tolls have been implemented to help mitigate the cost of maintaining toll roads, directing the cost of such maintenance onto the people that use such roads (as opposed to spreading these maintenance costs across the general populous).

Tolls were initially collected via tool booth attendants that collected cash-based tolls. However and as technology progressed, the collection of tolls became electronic via regional systems such as SunPass (in Florida) and EZPass (in the Northeast) and through the use of vehicle-mounted transponders and/or license plate scanning technology.

Unfortunately, the transponders used within one regional toll system may not be compatible with (or recognizable by) other regional toll systems. Further, license plates from one region may not be recognizable/processable within another region.

### SUMMARY OF DISCLOSURE

### Invention #3

In one implementation, a computer-implemented method is executed on a computing device and includes: receiving a vehicle identifier concerning a vehicle passing through a tolling area that requires a toll payment; providing the vehicle identifier to one or more remote entities to determine whether the vehicle identifier is remotely-identifiably by a specific remote entity; and if the vehicle identifier is remotely-identifiably by a specific remote entity, remotely-effectuating the toll payment concerning the tolling area via the specific remote entity.

One or more of the following features may be included. The vehicle identifier may include one or more of: a transponder signal; a vehicle-to-everything (V2X) signal and a vehicle license plate. The remote effectuation of the toll payment concerning the tolling area via the specific remote entity may be memorialized using distributed ledger technology. If the vehicle identifier is not remotely-identifiably by a specific remote entity, an attempt may be made to effectuate the toll payment via alternative payment methodologies. Attempting to effectuate the toll payment via alternative payment methodologies may include: attempting to effectuate the toll payment via mail-based payment methodologies. The vehicle identifier may be provided to one or more local entities to determine whether the vehicle identifier is locally-identifiably by a specific local entity. If the vehicle identifier is locally-identifiably by a specific local entity, the toll payment concerning the tolling area via the specific local entity may be locally-effectuated. The local effectuation of the toll payment concerning the tolling area via the specific local entity may be memorialized using distributed ledger technology. The vehicle identifier may be locally-identifiably if: the vehicle identifier is known locally, the vehicle identifier is associated with a registered user, the vehicle identifier is associated with a government account, the vehicle identifier is associated with a commercial account, and/or the vehicle identifier is associated with a known group of vehicle identifiers.

In another implementation, a computing system includes a processor and memory is configured to perform operations including receiving a vehicle identifier concerning a vehicle passing through a tolling area that requires a toll payment; providing the vehicle identifier to one or more remote entities to determine whether the vehicle identifier is remotely-identifiably by a specific remote entity; and if the vehicle identifier is remotely-identifiably by a specific remote entity, remotely-effectuating the toll payment concerning the tolling area via the specific remote entity.

One or more of the following features may be included. The vehicle identifier may include one or more of: a transponder signal; a vehicle-to-everything (V2X) signal and a vehicle license plate. The remote effectuation of the toll payment concerning the tolling area via the specific remote entity may be memorialized using distributed ledger technology. If the vehicle identifier is not remotely-identifiably by a specific remote entity, an attempt may be made to effectuate the toll payment via alternative payment methodologies. Attempting to effectuate the toll payment via alternative payment methodologies may include: attempting to effectuate the toll payment via mail-based payment methodologies. The vehicle identifier may be provided to one or more local entities to determine whether the vehicle identifier is locally-identifiably by a specific local entity. If the vehicle identifier is locally-identifiably by a specific local entity, the toll payment concerning the tolling area via the specific local entity may be locally-effectuated. The local effectuation of the toll payment concerning the tolling area via the specific local entity may be memorialized using distributed ledger technology. The vehicle identifier may be locally-identifiably if: the vehicle identifier is known locally, the vehicle identifier is associated with a registered user, the vehicle identifier is associated with a government account, the vehicle identifier is associated with a commercial account, and/or the vehicle identifier is associated with a known group of vehicle identifiers.

In another implementation, a computer program product resides on a computer readable medium and has a plurality of instructions stored on it. When executed by a processor, the instructions cause the processor to perform operations including receiving a vehicle identifier concerning a vehicle passing through a tolling area that requires a toll payment; providing the vehicle identifier to one or more remote entities to determine whether the vehicle identifier is remotely-identifiably by a specific remote entity; and if the vehicle identifier is remotely-identifiably by a specific remote entity, remotely-effectuating the toll payment concerning the tolling area via the specific remote entity.

One or more of the following features may be included. The vehicle identifier may include one or more of: a transponder signal; a vehicle-to-everything (V2X) signal and a vehicle license plate. The remote effectuation of the toll payment concerning the tolling area via the specific remote entity may be memorialized using distributed ledger technology. If the vehicle identifier is not remotely-identifiably by a specific remote entity, an attempt may be made to effectuate the toll payment via alternative payment methodologies. Attempting to effectuate the toll payment via alternative payment methodologies may include: attempting to effectuate the toll payment via mail-based payment methodologies. The vehicle identifier may be provided to one or more local entities to determine whether the vehicle identifier is locally-identifiably by a specific local entity. If the vehicle identifier is locally-identifiably by a specific local entity, the toll payment concerning the tolling area via the specific local entity may be locally-effectuated. The local effectuation of the toll payment concerning the tolling area via the specific local entity may be memorialized using distributed ledger technology. The vehicle identifier may be locally-identifiably if: the vehicle identifier is known locally, the vehicle identifier is associated with a registered user, the vehicle identifier is associated with a government account, the vehicle identifier is associated with a commercial account, and/or the vehicle identifier is associated with a known group of vehicle identifiers.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a toll settlement process according to an embodiment of the present disclosure;

FIG. 2 is a diagrammatic view of a plurality of regional toll collection systems according to an embodiment of the present disclosure;

FIG. 3 is a flowchart of an implementation of the toll settlement process of FIG. 1 according to an embodiment of the present disclosure;

FIG. 4 is a diagrammatic view of a vehicle interacting with a tolling area;

FIG. 5 is a diagrammatic view of a first of the regional toll collection systems of FIG. 2 according to an embodiment of the present disclosure;

FIG. 6 is a diagrammatic view of a second of the regional toll collection systems of FIG. 2 according to an embodiment of the present disclosure.

Like reference symbols in the various drawings indicate like elements.

### DETAILED DESCRIPTION OF THE PREFERRED EMBODIMENTS

System Overview

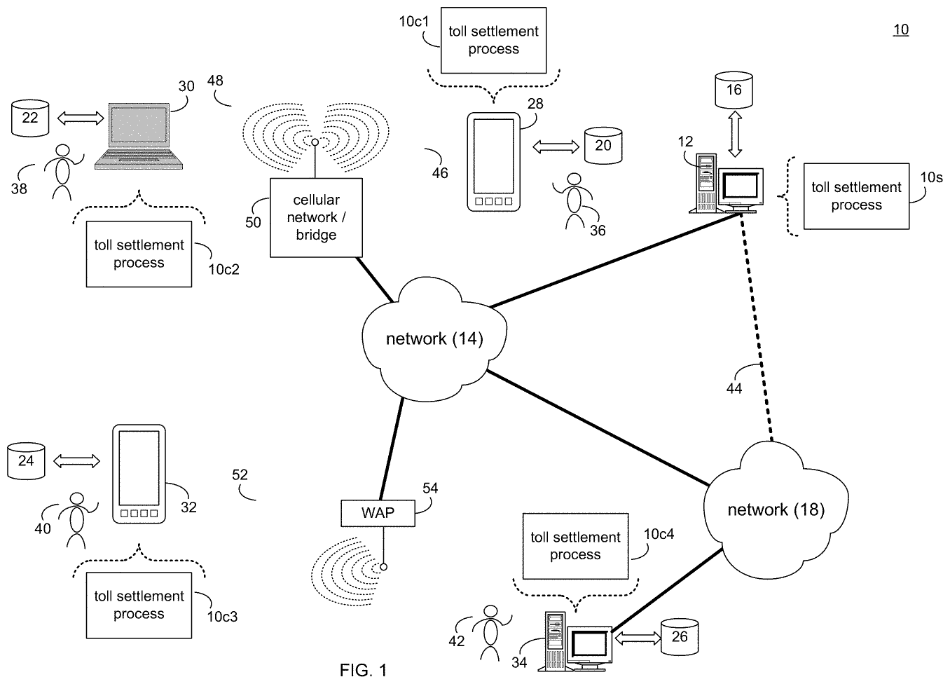

Referring to FIG. 1, there is shown toll settlement process 10. Toll settlement process 10 may be implemented as a server-side process, a client-side process, or a hybrid server-side/client-side process. For example, toll settlement process 10 may be implemented as a purely server-side process via toll settlement process 10s. Alternatively, toll settlement process 10 may be implemented as a purely client-side process via one or more of toll settlement process 10c1, toll settlement process 10c2, toll settlement process 10c3, and toll settlement process 10c4. Alternatively still, toll settlement process 10 may be implemented as a hybrid server-side/client-side process via toll settlement process 10s in combination with one or more of toll settlement process 10c1, toll settlement process 10c2, toll settlement process 10c3, and toll settlement process 10c4. Accordingly, toll settlement process 10 as used in this disclosure may include any combination of toll settlement process 10s, toll settlement process 10c1, toll settlement process 10c2, toll settlement process, and toll settlement process 10c4.

Toll settlement process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a cloud-based computing network.

The instruction sets and subroutines of toll settlement process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of toll settlement processes 10c1, 10c2, 10c3, 10c4 may include but are not limited to a client application, a web browser, a game console user interface, or a specialized application (e.g., an application running on e.g., the Android™ platform or the iOS™ platform). The instruction sets and subroutines of toll settlement processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage device 16 may include but are not limited to: a hard disk drive; a RAID device; a random access memory (RAM); a read-only memory (ROM); and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access toll settlement process 10 directly through network 14 or through secondary network 18. Further, toll settlement process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

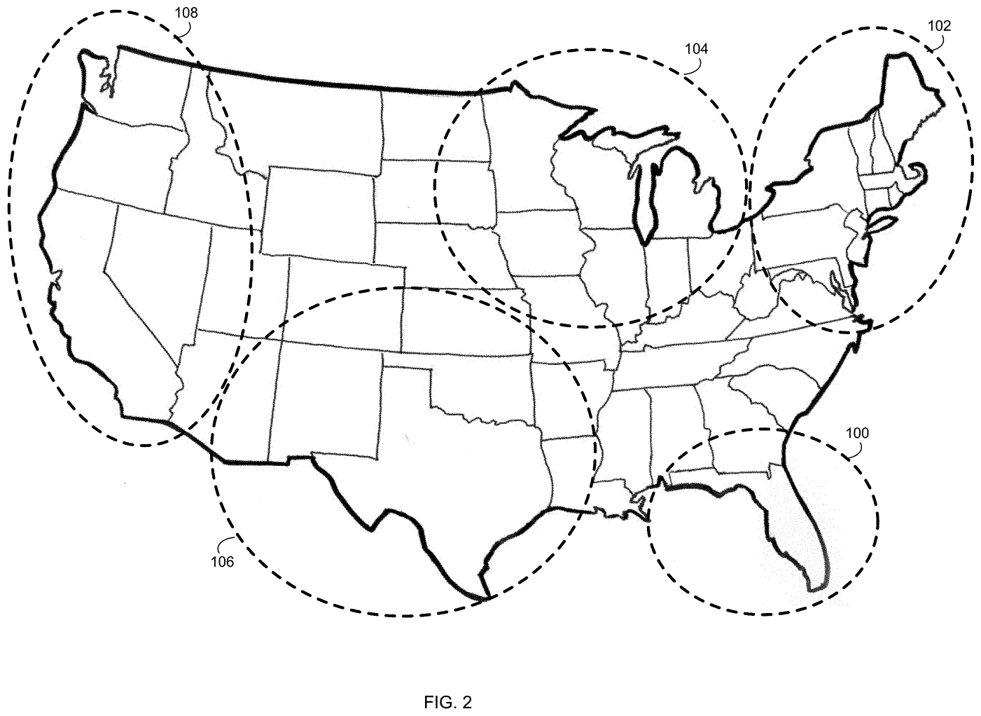

As discussed above, road tolls have been implemented to help mitigate the cost of maintaining roads, wherein the electronic collection of tolls is effectuated via regional tolling systems such as SunPass (in Florida) and EZPass (in the Northeast). Accordingly and referring also to FIG. 2, there is shown an exemplary toll collection infrastructure superimposed over a map of the United States of America. Specifically and for this illustrative example, a plurality of regional toll collection systems are shown. For example:
Southeast toll collection system 100 may be configured to effectuate the collection of tolls from vehicles passing through tolling areas (e.g., toll booths or toll collection points) in the southeastern United States;
Northeast toll collection system 102 may be configured to effectuate the collection of tolls from vehicles passing through tolling areas (e.g., toll booths or toll collection points) in the northeastern United States;
Midwest toll collection system 104 may be configured to effectuate the collection of tolls from vehicles passing through tolling areas (e.g., toll booths or toll collection points) in the Midwestern United States;
Southwest toll collection system 106 may be configured to effectuate the collection of tolls from vehicles passing through tolling areas (e.g., toll booths or toll collection points) in the southwestern United States; and
Westcoast toll collection system 108 may be configured to effectuate the collection of tolls from vehicles passing through tolling areas (e.g., toll booths or toll collection points) on the Westcoast of the United States.

Toll Settlement Process

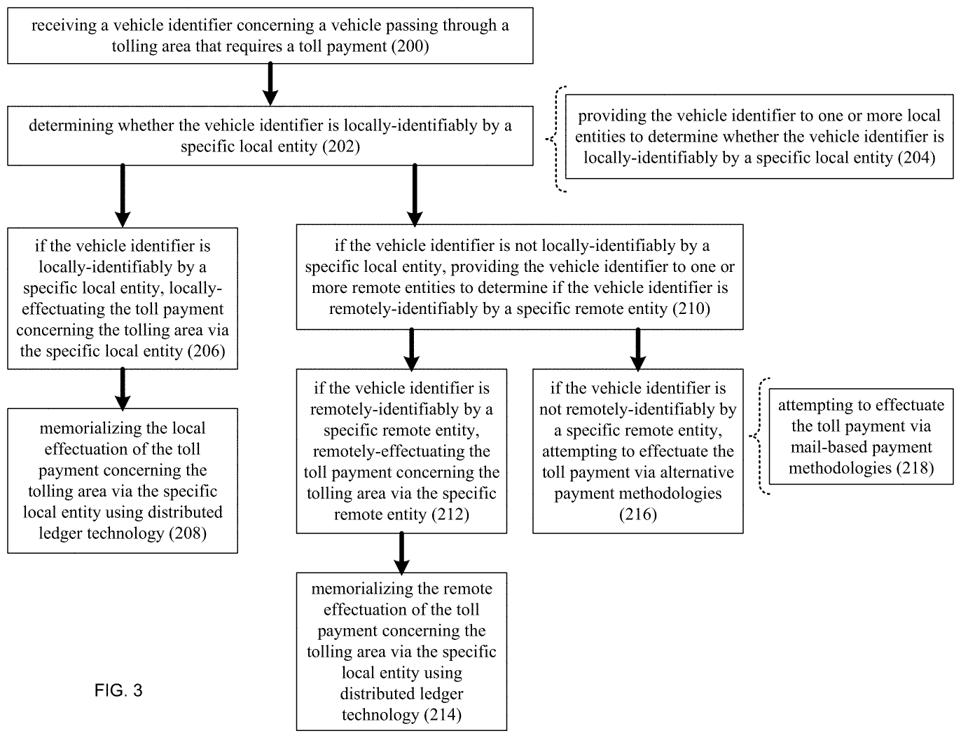

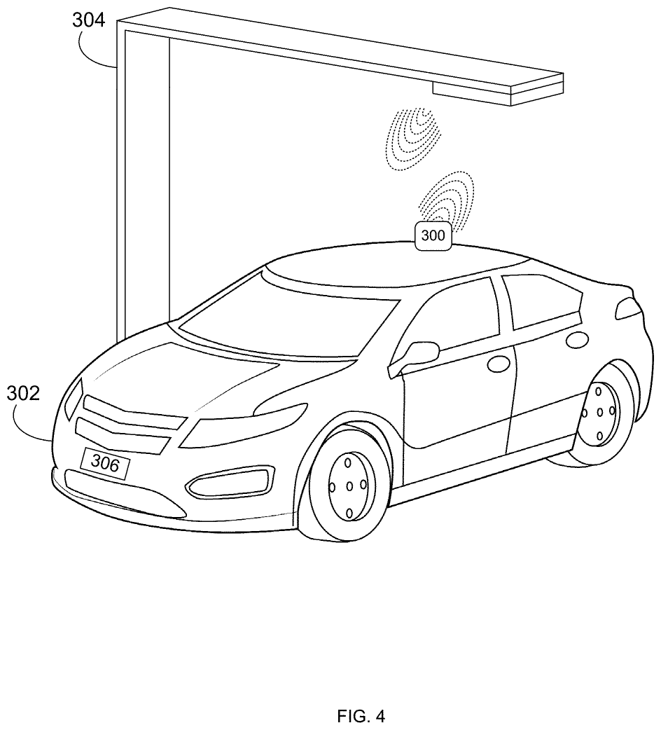

Referring also to FIGS. 3-4 and as will be discussed below in greater detail, toll settlement process 10 may be configured to may receive 200 a vehicle identifier (e.g., vehicle identifier 300) concerning a vehicle (e.g., vehicle 302) passing through tolling area (e.g., tolling area 304) that requires a toll payment (e.g., a fixed fee toll or a variable toll that depends upon distance travelled).

The vehicle identifier (e.g., vehicle identifier 300) may include one or more of: a transponder signal, a vehicle-to-everything (V2X) signal and a vehicle license plate. Specifically, vehicle identifier 300 may associate the vehicle (e.g., vehicle 302) with an specific account.

As is known in the art, a transponder is a wireless communications, monitoring or control device that receives and automatically responds to an incoming signal, wherein the signal provided by the transponder includes the vehicle identifier (e.g., vehicle identifier 300). Additionally, tolling area (e.g., tolling area 304) may include machine vision technology to read a license plate (e.g., license plate 306).

As is known in the art, a vehicle-to-everything (V2X) device is a system that passes information from a vehicle to any entity that may affect the vehicle (and vice versa), regardless of the supporting data transportation technology (i.e. DSRC, Cellular, 5G and VANET). Specifically, vehicle-to-everything (V2X) is a vehicular communication system that may incorporate other more specific types of communication as V2I (vehicle-to-infrastructure), V2N (vehicle-to-network), V2V (vehicle-to-vehicle), V2P (vehicle-to-pedestrian), V2D (vehicle-to-device) and V2G (vehicle-to-grid).

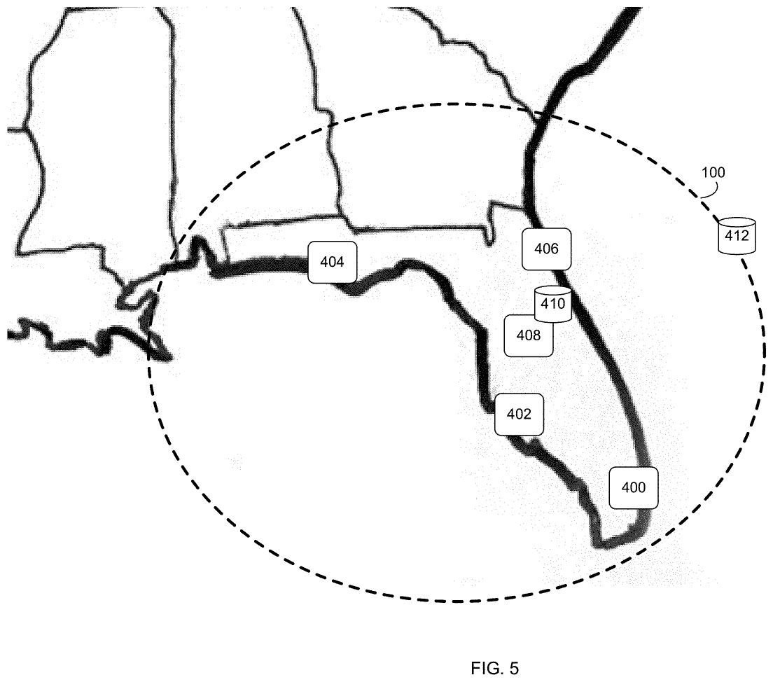

Once received 200, toll settlement process 10 may determine 202 whether the vehicle identifier (e.g., vehicle identifier 300) is locally-identifiably by a specific local entity. Referring also to FIG. 5, each of regional toll collection systems 100, 102, 104, 106, 108 may include one or more local entities (e.g., entities 400, 402, 404, 406, 408 in the case of toll collection systems 100), examples of which may include but are not limited to: individual users/license plates/transponders/vehicle-to-everything devices that are registered with (i.e., customers of) the local entity (e.g., individual user entity 400); fleet users/license plates/transponders/vehicle-to-everything devices that are associated with a fleet account (e.g., fleet user entity 402); commercial users/license plates/transponders/vehicle-to-everything devices that are associated with a commercial account (e.g., commercial user entity 404); government users/license plates/transponders/vehicle-to-everything devices that are associated with a government account (e.g., government user entity 406); and municipal users/license plates/transponders/vehicle-to-everything devices that are associated with a municipal account (e.g., municipal user entity 408).

Accordingly, the vehicle identifier (e.g., vehicle identifier 300) may be locally-identifiably if (for example):
the vehicle identifier (e.g., vehicle identifier 300) is known locally (e.g., included within one or more of entities 400, 402, 404, 406, 408).
the vehicle identifier (e.g., vehicle identifier 300) is associated with a registered user (e.g., a member of one or more of entities 400, 402, 404, 406, 408).
the vehicle identifier (e.g., vehicle identifier 300) is associated with a government account (e.g., a member of one or more of entities 406, 408).
the vehicle identifier (e.g., vehicle identifier 300) is associated with a commercial account (e.g., a member of one or more of entities 402, 404).
the vehicle identifier (e.g., vehicle identifier 300) is associated with a known group of vehicle identifiers (e.g., a group of users/license plates/transponders/vehicle-to-everything devices associated with one or more of entities 400, 402, 404, 406, 408).

When determining 202 whether the vehicle identifier (e.g., vehicle identifier 300) is locally-identifiably by a specific local entity, toll settlement process 10 may provide 204 the vehicle identifier (e.g., vehicle identifier 300) to one or more local entities (e.g., entities 400, 402, 404, 406, 408) to determine if the vehicle identifier (e.g., vehicle identifier 300) is locally-identifiably by the specific local entity (e.g., one or more of entities 400, 402, 404, 406, 408). For example, toll settlement process 10 may provide 204 vehicle identifier 300 to each of entities 400, 402, 404, 406, 408 so that each of entities 400, 402, 404, 406, 408 may compare vehicle identifier 300 to their list of e.g., registered user/members/license plates/transponders/vehicle-to-everything devices to determine whether vehicle identifier 300 is locally-identified.

If the vehicle identifier (e.g., vehicle identifier 300) is locally-identifiably by a specific local entity, toll settlement process 10 may locally-effectuate 206 the toll payment concerning the tolling area via the specific local entity. For example, if the transponder that provided vehicle identifier 300 is associated with a municipal vehicle owned by municipal user entity 408, toll settlement process 10 may locally-effectuate 206 the toll payment concerning the tolling area via the specific local entity (e.g., municipal user entity 408 may pay a $3.00 toll for vehicle 302 passing through tolling area 304).

Toll settlement process 10 may memorialize 208 the local effectuation of the toll payment concerning the tolling area via the specific local entity (e.g., municipal user entity 408 paying a $3.00 for vehicle 302 passing through tolling area 304) using distributed ledger technology. For example and when memorializing 208 such a local effectuation of the toll payment, toll settlement process 10 may update at least one distributed ledger (e.g., ledger 410 maintained by municipal user entity 408 and ledger 412 maintained by Southeast toll collection system 100) to memorialize e.g., municipal user entity 408 paying a $3.00 toll for vehicle 302 passing through tolling area 304. One example of such a distributed ledger (e.g., ledger 410 maintained by municipal user entity 408 and ledger 412 maintained by Southeast toll collection system 100) may include but is not limited to a blockchain ledger.

As is known in the art, a blockchain ledger may be a continuously growing list of records (e.g., called blocks) that are linked and secured using cryptography. For example, each block within a blockchain may contain a hash pointer as a link to a previous block. Accordingly, blockchains may be inherently resistant to modification of the data, as each block in the chain is linked (via a hash function) to the previous block in the chain. Accordingly, a block may include transaction data, a hash function that identifies the previous block in the blockchain ledger, and a time/date stamp. Functionally, a blockchain ledger may serve as an open, distributed ledger that may securely record transactions between two parties (e.g., municipal user entity 408 and Southeast toll collection system 100) efficiently and in a verifiable and permanent way.

If the vehicle identifier (e.g., vehicle identifier 300) is not locally-identifiably, toll settlement process 10 may provide 210 the vehicle identifier (e.g., vehicle identifier 300) to one or more remote entities to determine if the vehicle identifier (e.g., vehicle identifier 300) is remotely-identifiably by a specific remote entity.

As discussed above, an exemplary toll collection infrastructure may include a plurality of regional toll collection systems, wherein each of regional toll collection systems (e.g., toll collection systems 100, 102, 104, 106, 108) may include one or more discrete entities. For the following example, the discrete entities within toll collection system 102 are going to be described. However, this is for illustrative purposes only and is not intended to be a limitation of this disclosure, as it is understood that any of the regional toll collection systems (e.g., toll collection systems 100, 102, 104, 106, 108) may include one or more discrete entities.

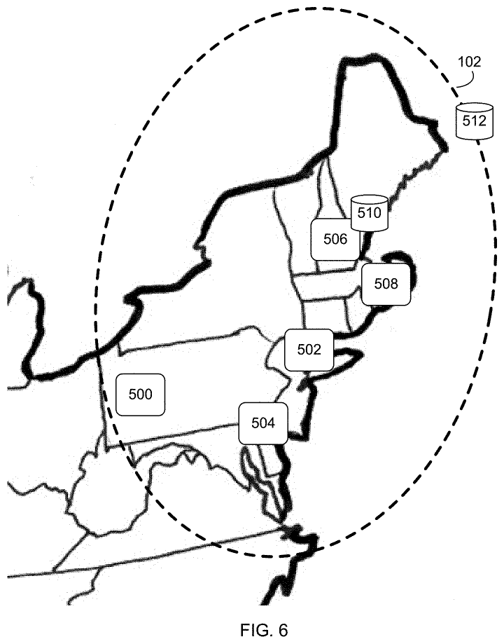

Referring also to FIG. 6, toll collection system 102 is shown to include five discrete entities (e.g., entities 500, 502, 504, 506, 508), examples of which may include but are not limited to: individual users/license plates/transponders/vehicle-to-everything devices that are registered with (i.e., customers of) the remote entity (e.g., individual user entity 500); fleet users/license plates/transponders/vehicle-to-everything devices that are associated with a fleet account (e.g., fleet user entity 502); commercial users/license plates/transponders/vehicle-to-everything devices that are associated with a commercial account (e.g., commercial user entity 504); government users/license plates/transponders/vehicle-to-everything devices that are associated with a government account (e.g., government user entity 506); and municipal users/license plates/transponders/vehicle-to-everything devices that are associated with a municipal account (e.g., municipal user entity 508).

Accordingly and when providing 210 the vehicle identifier (e.g., vehicle identifier 300) to one or more remote entities to determine if the vehicle identifier (e.g., vehicle identifier 300) is remotely-identifiably by a specific remote entity, toll settlement process 10 may provide the vehicle identifier (e.g., vehicle identifier 300) the other regional toll collection systems (e.g., toll collection systems 102, 104, 106, 108) so that these regional toll collection systems (e.g., toll collection systems 102, 104, 106, 108) may provide the vehicle identifier (e.g., vehicle identifier 300) to their respective discrete entities (e.g., entities 500, 502, 504, 506, 508 in the case of toll collection systems 102) so that these discrete entities (e.g., entities 500, 502, 504, 506, 508 in the case of toll collection systems 102) may determine if the vehicle identifier (e.g., vehicle identifier 300) is remotely-identifiably by a specific remote entity. For example, toll settlement process 10 may provide vehicle identifier 300 to each of entities 500, 502, 504, 506, 508 (in the case of toll collection systems 102) so that each of entities 500, 502, 504, 506, 508 (in the case of toll collection systems 102) may compare vehicle identifier 300 to their list of e.g., registered user/members/license plates/transponders/vehicle-to-everything devices to determine whether vehicle identifier 300 is remotely-identified.

If the vehicle identifier (e.g., vehicle identifier 300) is remotely-identifiably by a specific remote entity, toll settlement process 10 may remotely-effectuate 212 the toll payment concerning the tolling area via the specific remote entity. For example, if the transponder that provided vehicle identifier 300 is associated with a commercial vehicle owned by government user entity 506, toll settlement process 10 may remotely-effectuate 212 the toll payment concerning the tolling area via the specific remote entity (e.g., government user entity 506 may pay a $3.00 toll for vehicle 302 passing through tolling area 304).

Toll settlement process 10 may memorialize 214 the remote effectuation of the toll payment concerning the tolling area via the specific remote entity (e.g., government user entity 506 paying a $3.00 toll for vehicle 302 passing through tolling area 304) using distributed ledger technology. For example and when memorializing 214 such a remote effectuation of the toll payment, toll settlement process 10 may update at least one distributed ledger (e.g., ledger 510 maintained by government user entity 506 and ledger 512 maintained by Northeast toll collection system 102) to memorialize e.g., government user entity 506 paying a $3.00 toll for vehicle 302 passing through tolling area 304. As discussed above, one example of such a distributed ledger (e.g., ledger 510 maintained by government user entity 506 and ledger 512 maintained by Northeast toll collection system 102) may include but is not limited to a blockchain ledger.

If the vehicle identifier (e.g., vehicle identifier 300) is not remotely-identifiably by a specific remote entity (e.g., none of the discrete entities within any of regional tolling authorities 100, 102, 104, 106, 108 can identify vehicle identifier 300), toll settlement process 10 may attempt 216 to effectuate the toll payment via alternative payment methodologies, wherein attempting 216 to effectuate the toll payment via alternative payment methodologies may include attempting 218 to effectuate the toll payment via mail-based payment methodologies. As discussed above, tolling area (e.g., tolling area 304) may include machine vision technology to read a license plate (e.g., license plate 306). Accordingly, the vehicle identifier (e.g., vehicle identifier 300) may be license plate 306 and, therefore, the appropriate motor vehicle registry may be contacted by toll settlement process 10 to obtain the address of the plate holder so that the plate holder may be invoiced via mail.

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing device, comprising:
receiving a vehicle identifier concerning a vehicle passing through a tolling area that requires a toll payment;
providing the vehicle identifier to one or more remote entities to determine whether the vehicle identifier is remotely-identifiably by a specific remote entity; and
if the vehicle identifier is remotely-identifiably by a specific remote entity, remotely-effectuating the toll payment concerning the tolling area via the specific remote entity.

2. The computer-implemented method of claim 1 wherein the vehicle identifier includes one or more of:
a transponder signal;
a vehicle-to-everything signal; and
a vehicle license plate.

3. The computer-implemented method of claim 1 further comprising:
memorializing the remote effectuation of the toll payment concerning the tolling area via the specific remote entity using distributed ledger technology.

4. The computer-implemented method of claim 1 further comprising:
if the vehicle identifier is not remotely-identifiably by a specific remote entity, attempting to effectuate the toll payment via alternative payment methodologies.

5. The computer-implemented method of claim 4 wherein attempting to effectuate the toll payment via alternative payment methodologies includes:
attempting to effectuate the toll payment via mail-based payment methodologies.

6. The computer-implemented method of claim 1 further comprising:
providing the vehicle identifier to one or more local entities to determine whether the vehicle identifier is locally-identifiably by a specific local entity.

7. The computer-implemented method of claim 6 further comprising:
if the vehicle identifier is locally-identifiably by a specific local entity, locally-effectuating the toll payment concerning the tolling area via the specific local entity.

8. The computer-implemented method of claim 7 further comprising:
memorializing the local effectuation of the toll payment concerning the tolling area via the specific local entity using distributed ledger technology.

9. The computer-implemented method of claim 6 wherein the vehicle identifier is locally-identifiably if:
the vehicle identifier is known locally;
the vehicle identifier is associated with a registered user;
the vehicle identifier is associated with a government account;
the vehicle identifier is associated with a commercial account; and/or
the vehicle identifier is associated with a known group of vehicle identifiers.

10. A computer program product residing on a computer readable medium having a plurality of instructions stored thereon which, when executed by a processor, cause the processor to perform operations comprising:
receiving a vehicle identifier concerning a vehicle passing through a tolling area that requires a toll payment;
providing the vehicle identifier to one or more remote entities to determine whether the vehicle identifier is remotely-identifiably by a specific remote entity; and
if the vehicle identifier is remotely-identifiably by a specific remote entity, remotely-effectuating the toll payment concerning the tolling area via the specific remote entity.

11. The computer program product of claim 10 wherein the vehicle identifier includes one or more of:
a transponder signal;
a vehicle-to-everything signal; and
a vehicle license plate.

12. The computer program product of claim 10 further comprising:
memorializing the remote effectuation of the toll payment concerning the tolling area via the specific remote entity using distributed ledger technology.

13. The computer program product of claim 10 further comprising:
if the vehicle identifier is not remotely-identifiably by a specific remote entity, attempting to effectuate the toll payment via alternative payment methodologies.

14. The computer program product of claim 13 wherein attempting to effectuate the toll payment via alternative payment methodologies includes:
attempting to effectuate the toll payment via mail-based payment methodologies.

15. The computer program product of claim 10 further comprising:
providing the vehicle identifier to one or more local entities to determine whether the vehicle identifier is locally-identifiably by a specific local entity.

16. The computer program product of claim 15 further comprising:
if the vehicle identifier is locally-identifiably by a specific local entity, locally-effectuating the toll payment concerning the tolling area via the specific local entity.

17. The computer program product of claim 16 further comprising:
memorializing the local effectuation of the toll payment concerning the tolling area via the specific local entity using distributed ledger technology.

18. The computer program product of claim 15 wherein the vehicle identifier is locally-identifiably if:
the vehicle identifier is known locally;
the vehicle identifier is associated with a registered user;
the vehicle identifier is associated with a government account;
the vehicle identifier is associated with a commercial account; and/or
the vehicle identifier is associated with a known group of vehicle identifiers.

19. A computing system including a processor and memory configured to perform operations comprising:
receiving a vehicle identifier concerning a vehicle passing through a tolling area that requires a toll payment;
providing the vehicle identifier to one or more remote entities to determine whether the vehicle identifier is remotely-identifiably by a specific remote entity; and
if the vehicle identifier is remotely-identifiably by a specific remote entity, remotely-effectuating the toll payment concerning the tolling area via the specific remote entity.

20. The computing system of claim 19 wherein the vehicle identifier includes one or more of:
a transponder signal;
a vehicle-to-everything signal; and
a vehicle license plate.

21. The computing system of claim 19 further comprising:
memorializing the remote effectuation of the toll payment concerning the tolling area via the specific remote entity using distributed ledger technology.

22. The computing system of claim 19 further comprising:
if the vehicle identifier is not remotely-identifiably by a specific remote entity, attempting to effectuate the toll payment via alternative payment methodologies.

23. The computing system of claim 22 wherein attempting to effectuate the toll payment via alternative payment methodologies includes:
attempting to effectuate the toll payment via mail-based payment methodologies.

24. The computing system of claim 19 further comprising:
providing the vehicle identifier to one or more local entities to determine whether the vehicle identifier is locally-identifiably by a specific local entity.

25. The computing system of claim 24 further comprising:
if the vehicle identifier is locally-identifiably by a specific local entity, locally-effectuating the toll payment concerning the tolling area via the specific local entity.

26. The computing system of claim 25 further comprising:
memorializing the local effectuation of the toll payment concerning the tolling area via the specific local entity using distributed ledger technology.

27. The computing system of claim 24 wherein the vehicle identifier is locally-identifiably if:
the vehicle identifier is known locally;
the vehicle identifier is associated with a registered user;
the vehicle identifier is associated with a government account;
the vehicle identifier is associated with a commercial account; and/or
the vehicle identifier is associated with a known group of vehicle identifiers.
